(19) United States
(12) Patent Application Publication
(10) Pub. No.: US 2026/0310652 A1
(43) Pub. Date: Oct. 8, 2026

(54) EXTERNAL SERVICE INVOCATION

(71) Applicant: Wells Fargo, N.A., San Francisco, CA (US)

(72) Inventor: Nalini Krishna Teja Chalasani, Edison, NJ (US)

(21) Appl. No.: 19/169,970

(22) Filed: Apr. 3, 2025

(51) Int. Cl. G06F 16/23; G06F 16/2455; G06F 16/27

(52) U.S. Cl. CPC G06F 16/2358; G06F 16/24552; G06F 16/27

(57) ABSTRACT

System and techniques for triggering the invocation of an external service are described herein. A system can receive copy of a portion of a database from an external entity, where the copy includes a record. The system can access a local version of the record to find an indication that the record received is different than the local version of the record and trigger an event for the record based on the indication that the record is different than the local version of the record. The system can then transmit, based on the event, a request corresponding to the record to an interface. The system can update a local cache corresponding to the record with a response to the request made to the interface.

### TECHNICAL FIELD

Embodiments described herein generally relate to computer networking and more specifically to external service invocation.

### BACKGROUND

Computer network services enable communication between distributed systems by facilitating data exchange through various protocols and interfaces. One fundamental aspect of network services is the use of Application Programming Interfaces (APIs) to structure communication between clients and servers. A common example is a Representational State Transfer (RESTful) API, which adheres to REST architectural principles by using stateless client-server communication, a uniform interface, and resource-based interactions. RESTful APIs typically use Hypertext Transfer Protocol (HTTP) methods such as GET, POST, PUT, and DELETE to interact with resources identified by Uniform Resource Identifiers (URIs). For example, a RESTful API for a cloud-based file storage service may expose endpoints such as/files/{id} to retrieve, update, or delete a specific file. Remote Procedure Call (RPC) endpoints, in contrast, enable direct execution of functions on remote servers by invoking predefined procedures. Unlike REST, RPC-based interfaces such as gRPC use Protocol Buffers (protobuf) for efficient serialization and support bidirectional streaming, which can be beneficial in high-performance distributed systems.

### BRIEF DESCRIPTION OF THE DRAWINGS

In the drawings, which are not necessarily drawn to scale, like numerals may describe similar components in different views. Like numerals having different letter suffixes may represent different instances of similar components.

The drawings illustrate generally, by way of example, but not by way of limitation, various embodiments discussed in the present document.

FIG. 1 is a block diagram of an example of an environment including a system for external service invocation, according to an embodiment.

FIG. 2 illustrates an example of an architecture for external service invocation, according to an embodiment.

FIG. 3 illustrates an example of messaging between components including an external application programming interface call, according to an embodiment.

FIG. 4 illustrates an example of messaging between components, according to an embodiment.

FIG. 5 illustrates a flow diagram of an example of a method for external service invocation, according to an embodiment.

FIG. 6 is a block diagram illustrating an example of a machine upon which one or more embodiments may be implemented.

### DETAILED DESCRIPTION

When, where, or how to invoke an external service can vary widely by context. For example, typical user interfaces that rely on remote services trigger the call to the remote service when requested by the user. Schedule based requests can be triggered at certain times to, for example, process data overnight or at other convenient times. The situation can be more complicated when, for example, an on-demand request would be most convenient for a user but the logistics (e.g., bandwidth or processing power) to perform such requests is prohibitive. Consider the situation of data sources that are subject to change through large volumes of transactions where the individual transactions are handled by a transaction processor. In general, transaction processing enables systematic handling of transaction data through collection, validation, or entry into a database.

Third-party processors (e.g., an external entity to the database) can collect transaction information throughout an operational period, store transaction information within secure storage systems, or compile transaction information into complete reports at the end of a defined cycle. Transaction processing can include standardized message formats for ingestion or concurrency controls to ensure data integrity. Transaction data can then be routed for further processing through an application programming interface (API) or integrated with external services to enable tasks such as auditing, analytic calculations, or compliance checks. Transaction processing emphasizes the organization of collected data to ensure consistent, accurate information for subsequent operations in distributed systems.

An issue can arise in which the form of the transaction data that is reincorporated into a data base is created by the external service. Thus, to update the database, the variety of transaction data is collected by the external entity in a raw form and processed (e.g., normalized, filtered, expanded, etc.) into a final form before the transaction data can be used to update the database. However, because the external service is called, and does not notify the database (or the system hosting the database) of changes, the database is responsible for scheduling calls to get up-to-date information to update itself. An issue can arise in large volume or size transaction systems in which it is not practical to routinely make the external service calls to keep the database up-to-date in near real time (e.g., every minute or so). Even if the systems were implemented with enough processing and bandwidth to perform such frequent calls, there can be great inefficiency because many of the records requested can be unchanged, resulting in frequently throwing away the result or overwriting the same data in the database. Accordingly, many systems with these characteristics tend to a relatively slow schedule for implementing remote service calls, such as once a day (e.g., in the evening or during lower-volume periods). While this approach is more efficient it also tends to cause the database data to be stale for much of a day, or whatever period is used.

While it can be possible to build a trigger or notification system into the external service to call the database to trigger the remote service call, such modifications to the external service can be brittle (e.g., are overly reliant on specific processing characteristics of the database that are likely to be different or change given different implementations of the database) and impose additional restrictions on the transaction processing facility.

The address the issues noted above, external service invocation can be triggered using a hybrid approach were the external entity mirrors raw data from the transactions (e.g., employs table replication of one or more transaction tables) to a system that has access to the database. This raw data is not in its final form and thus likely cannot be used to directly update the database. However, the raw data can be used to identify, for example, transaction targets (e.g., records, accounts, etc.) that have changed (e.g., the mirror indicates a difference over a last mirror). Once the transaction targets are identified, then an event for the transaction target is triggered. The event causes the remote service to be invoked (e.g., called) to obtain the final data for these targets and the database can be updated with the final data. In this way, a standard database mirroring technique can be used from the external entity to the database system to enable the database system to detect changes. However, no additional processing pipeline need be implemented by the external entity and the database system judiciously employs the external service invocation based on these detected changes to use the standard data finalization available in the external service without excessive calls to unchanged data. This triggering pipeline results in a near-real-time update to the database. Additional details and examples are described below.

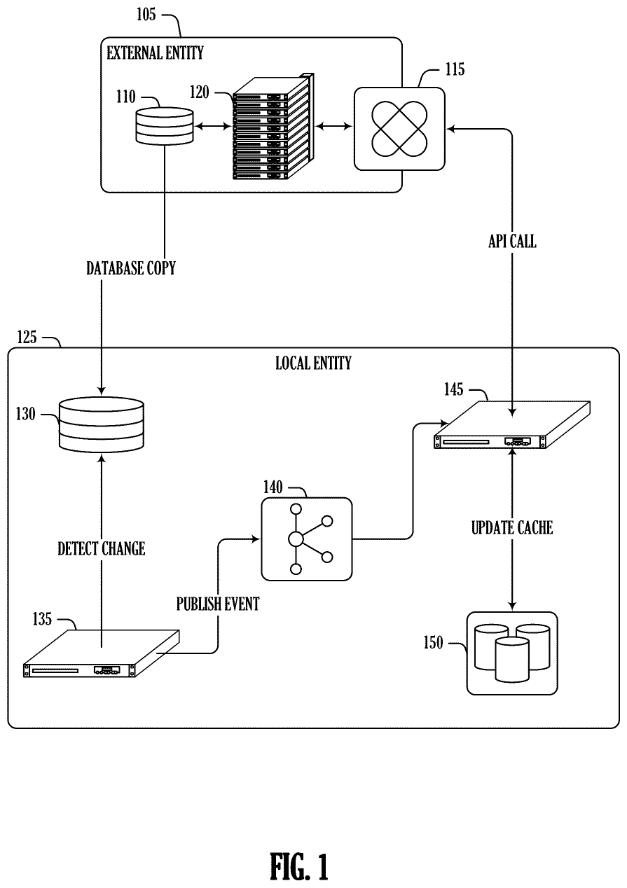

FIG. 1 is a block diagram of an example of an environment including a system 125 for external service invocation, according to an embodiment. To differentiate between local interactions and interactions with the remote service 115, the system 125 is labeled the local entity and the service system 105 is labeled as the external entity. The service system 105 includes a transaction database 110 that holds transaction data, a processing facility 120, and the remote service 115. The remote service 115 can be implemented in variety of ways, including as an RPC, web-endpoint, or the like. The processing facility 120 can implement the remote service 115, or the processing facility 120 can create the final data that is served by the remote service 115.

Thus, the processing facility 120 is configured to derive final data from transaction data in the transaction database 110. This derivation can include one or more processing operations, including aggregation, reduction, de-duplication, filtering, data expansion (e.g., adding user data from another data based on a user identifier (ID) in the transaction data), filtering, thresholding, etc. The transaction database 110 is configured to hold transaction data collected, for example, from terminals (e.g., a point-of-sale (POS) terminal, automated teller machine, workstation, etc.). Generally, in operation, transactions are recorded in the transaction database 110 as they occur at a terminal and the processing facility 120 uses that transaction data to produce final data. When a request is made of the remote service 115, the final data is returned in response. In an example, the processing facility 120 can produce the final data in response to the request at the remote service 115, the processing facility 120 can produce the final data in response to the transaction data being updated in the transaction database 110, or the processing facility can produce the final data upon another event (e.g., a threshold number of transactions are changed, a timer has expired, etc.).

The system 125 includes processing circuitry, storage (e.g., power-stable storage such as a hard drive, solid state drive, etc.), and memory. These elements can be distributed across different physical enclosures (e.g., cases, computers, etc.) or these elements can be collocated in such physical enclosures. The processing circuitry The memory is generally used to maintain running state information for the system 125 that is usually discarded between system power cycles or restarts. The memory and the storage are both forms of computer readable media. The processing circuitry—or software residing in the memory or storage executing on the processing circuitry—configure the system 125 to perform various operations when in running. In the specific implementation illustrated, the storage includes a local transaction database 130 and a representation of the local database, such as the cache 150. The storage can also be used to implement parts of a messaging facility 140.

The processing circuitry and the memory are distributed across two machines (e.g., physical servers, virtual machines, clusters, etc.), a first machine 135 and a second machine 145. In general, the first machine 135 is configured to detect changes in a record in the local transaction database 130 and to generate an event for the record that has changed. This event is then published to the messaging facility 140 to be delivered (e.g., sent, published, etc.) to the second machine 145. The second machine 145 is configured to act upon the event for the record by formulating and executing a remote call (e.g., a request) to the remote service 115 to obtain final data for the record. The second machine 145 is configured to then write that final data to the representation of the local database, such as by updating the cache 150 of the local database. This representation of the local database can then be used by other local services to act upon up-to-date transaction information for the local database.

The following examples simplify the operational elements to illustrate the interactions from the processing circuitry or storage in the system 125 with other components, wherever they reside. Thus, the processing circuitry is configured to receive a copy of a portion of a database (e.g., the transaction database 110) is received from an external entity (e.g., the service system 105). The receipt of the portion of the database can be based on a request by the processing circuitry, based on a periodic transmission of the service system 105, or by some other event. In an example, the copy includes a record. In an example, the portion of the database is a database table. Thus, while other data forms can be used (e.g., Javascript Object Notation (JSON) encoded data, extensible markup (XML) encoded data, or the like), these last examples illustrate using table replication to transfer the transaction data to the system 125.

The processing circuitry is configured to access a local version of the record (e.g., in the local transaction database 130) to find an indication that the record is different than the local version of the record. As noted above and below, the purpose of this operation is to determine which records are different in order to later trigger an update of a local version of that record via a call to the remote service 115 and to avoid requests for records that have not changed. In an example, the indication that the record is different includes a failure to match values between the record and the local version of the record in a set of fields. Here, specific fields in the local version and the received version of the record are compared. In an example, a match is exact. Here, an exact match can include identical bit representations of values in the fields or can include a value based match even if not bitwise identical (e.g., a 64 bit value of ‘1’ matches a 32 bit value of ‘1’ even though the bits are not identical). Generally, however, when table replication is used a bitwise match will occur when the fields match. In an example, the set of fields is all fields of the record. Here, the complete record, rather than a proper subset of the record, is matched to find the indication that the record has changed. In an example, a failure to match occurs when, given a field, a first value in the record for the record and a second value in the field for the local version of the record are different from each other.

The processing circuitry is configured to trigger an event for the record based on the indication that the record is different than the local version of the record. This triggering can take several forms. For example, if the system 125 is implemented in a single machine in a single operating environment (e.g., within a program), then the triggering can include putting a function call (e.g. a method call) on an execution stack for the operating environment. Other types of triggers, such as messages, interrupts, etc. can also be used. In an example, triggering the event includes publishing a message for the event on a message bus, for example, hosted by the message facility.

Generally, message buses facilitate asynchronous communication between devices or systems by enabling message-based data exchange across multiple producers and consumers. A message bus decouples applications, improving scalability, reliability, and fault tolerance in event-driven architectures. Apache Kafka is an example of a distributed message bus designed for high-throughput, fault-tolerant, and real-time event streaming. Kafka organizes messages into topics, where producers publish data, and consumers subscribe to process messages asynchronously. Kafka uses a distributed log-based storage model and partitions data across multiple brokers, ensuring scalability and parallel processing. Other message bus systems, such as RabbitMQ and NATS, provide similar functionalities with different architectural approaches. RabbitMQ follows the Advanced Message Queuing Protocol (AMQP) and supports flexible message routing through exchanges and queues, making it suitable for complex messaging workflows. NATS, a lightweight and high-performance messaging system, focuses on low-latency communication and event streaming in microservices architectures. Message buses enhance decoupling in distributed systems by buffering messages, handling backpressure, and supporting event-driven designs, enabling reliable and efficient data exchange across cloud-native applications and enterprise systems.

The processing circuitry is configured to, based on the event being triggered, transmit a request corresponding to the record to an interface (e.g., the remote service 115) to update a local cache (e.g., the cache 150, another representation of the local database, or the local database itself) corresponding to the record with a response to the request. Thus, the event indicates which record has changed and the remote service 115 is invoked with respect to that record to get final data for the record. It is this final data that is used to update the cache 150 or other representation of the local database.

In an example, data in the response includes a value that is not in the record. This example demonstrates that the final data received from the remote service 115 can include information (e.g., added by the processing facility 120) that is absent from the raw transactional data in the transaction database 110 or the local transaction database 130. In an example, the interface (e.g., the remote service 115) accepts the request, derives the value (e.g., by the processing facility 120) from a local source (e.g., the transaction database 110), and adds the value to the response. In an example, the interface is implemented by the external entity.

A variety of techniques can be used to connect the record to the representation of the data corresponding to the record in the local database (e.g., in the cache 150). If there is not a straightforward connection (e.g., based on an account number), some type of processing can be used to calculate an identifier for the record that can then be used to local the corresponding entries in the local database. In an example, the processing circuitry is configured to generate an identifier based on the record. In an example, the identifier is a key to the local cache (e.g., the cache 150). In an example, the record is part of a set of records. In an example, the set of records includes meta data. In an example, the identifier is derived from the meta data. In an example, the identifier is a hash of some or a portion of the meta data. Other types of fingerprinting can be used, including storing selected fields of the record in a map that includes a local database key, or keys, that can be used to identify the records in the local database that correspond to the record received from the service system 105. However, using a hash can provide a more direct and elegant technique to produce the identifier for the record.

When the final data is received, the local database, or its representation, can be updated to make the new information available for use. In an example, the processing circuitry is configured to delete an entry in the cache 150 that matches the identifier. In an example, deleting the entry in the cache includes overwriting the entry with data in the response to the request. Thus, the up-to-date information derived via the remote service 115 can be used or served from the system 125.

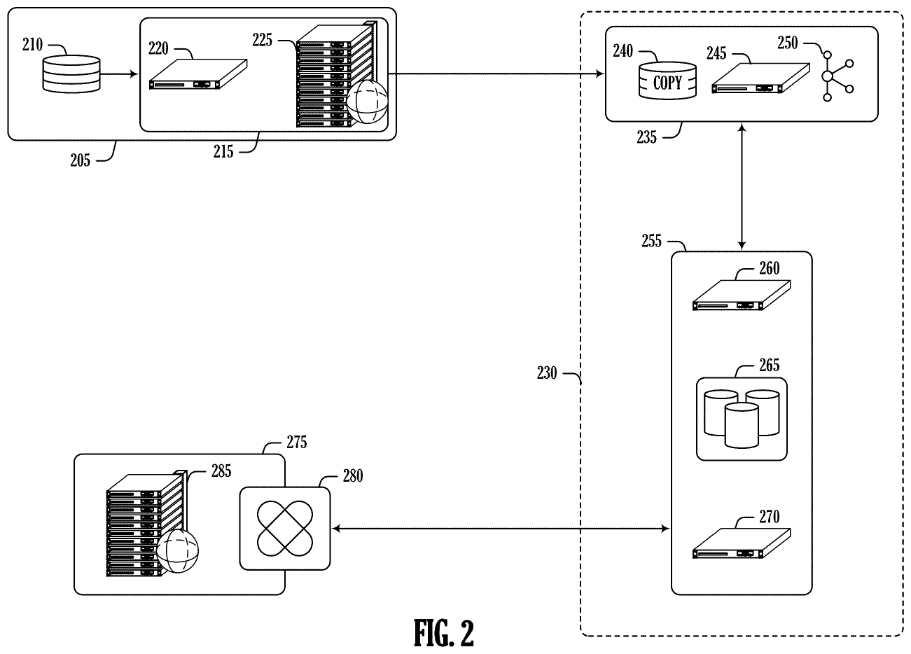

FIG. 2 illustrates an example of an architecture for external service invocation, according to an embodiment. In the illustrated example, a transaction processing system 205 collects transaction data in a database 210. A processing facility 215 includes a database host 220 that manages the database 210 and a network capable cluster 225 that can provide a replica of some or all of the database 210 to network attached systems, such as the local system 230.

The local system 230 includes a replication system 235 that includes a local database 240 to hold the replica data received from the transaction processing system 205. A machine 245 has access to the local database 240, and is configured to detect an indication that a record in the copy has changed from a previous version of the record held in the local database 240. The machine 245 publishes a message on the message bus 250.

The update system 255 includes a machine 260 configured to manage a local cache 265 and a machine 270 configured to perform remote service invocation (e.g., to make a call to a remote service, such as the API gateway 280). The message published to the message bus 250 provided to either the machine 260, the machine 270, or both via a transmission of the message, a notification that the message is available, or via a retrieve operation from either machine. In any case, the machine 270, based on the message, invokes the API gateway 280 with respect to the record to obtain updated information (e.g., final data). Once the updated information is received by the machine 270, the machine 260 can use the updated information to update the local cache 265.

The remote service system 275 hosts the API gateway 280. As noted above, the response provided to a request by the API gateway 280 is not the raw (e.g., unmodified) transaction data collected by the transaction processing system 205. Rather, the raw transaction data is modified by the processing facility 285 to generate the data provided by the API gateway 280 in response to a request. While the remote service system 275 is pictured here as separate from the transaction processing system 205, in an example, these two systems can be hosted together (e.g., in a same machine, cluster, datacenter, operator, etc.).

Consider this architecture, or that described above with respect to FIG. 1, in the context of a bank transaction scenario. Generally, a vendor manages banking transactional data, with some data being stored in the bank only after business hours. The objective is to enable this data to be stored in internal databases in near real-time, with an expected latency of up to 30 seconds. Ideally, the vendor would provide a real-time data streaming mechanism using technologies such as Kafka or Message Queue. However, such a capability is not available, necessitating a different approach to ensure timely data availability.

The external service invocation described herein address real-world constraints that often arise. Generally, the vendor does not support real-time data push mechanisms and only supports database replication in near real-time. The replicated data is raw and lacks logic since the logic resides in the vendor's microservices (e.g., external interfaces). The described system operates with a latency of up to 30 seconds, which is acceptable within the defined constraints. The vendor may provide only two mechanisms for data retrieval: REST and SOAP APIs.

The described system (e.g., the local system 230) includes several elements, such as database replication, event generation from replication, event processing, trigger mechanisms, and application cache updates. Transactional data from the vendor's SQL database is replicated to an internal SQL database on a table-by-table basis. This replication process operates with a latency of up to 30 seconds. A message-based tool using a Change Data Capture (CDC) tool (e.g., Debezium) is employed to perform CDC on the replicated SQL data. The CDC tool detects data changes and generates events accordingly.

The CDC-generated events serve as triggers indicating data changes. When an event is detected, the system pulls the corresponding data from the vendor's REST or SOAP API to retrieve the full context data, a Universally Unique Identifier (UUID) specific to the record can be generated based on the request payload, mapping the response to the request UUID. Here, UUID refers to an identifier that is universally unique to the record but is always the same when generated from the record as opposed to a general purpose UUID. When an event is received, the system constructs a request payload using key data elements, such as an account number, and checks for an existing UUID entry in the cache. If an entry exists, the system invokes the vendor's API using the relevant data element, retrieves the response, and updates the cache. This ensures that the cache remains up to date in near real-time.

In an example, the caching mechanism can allow stale data to persist for ten to fifteen minutes in case of updates. In an example, the cache is updated within thirty seconds (give or take thirty seconds) to enable near real-time data accuracy. In an example, caching is performed only when an account has been accessed within a specific period, minimizing unnecessary API calls and storage costs for inactive accounts.

In scenarios where downstream APIs cannot handle frequent updates due to restrictive Service Level Agreements, the cache behavior can be modified. Instead of keeping records updated, the system deletes the cache entry when an update occurs. This allows for all the previously mentioned benefits while reducing the frequency of calls to downstream systems. For example, in the case of the Position API, this modification prevents excessive API calls while maintaining accurate and updated data retrieval.

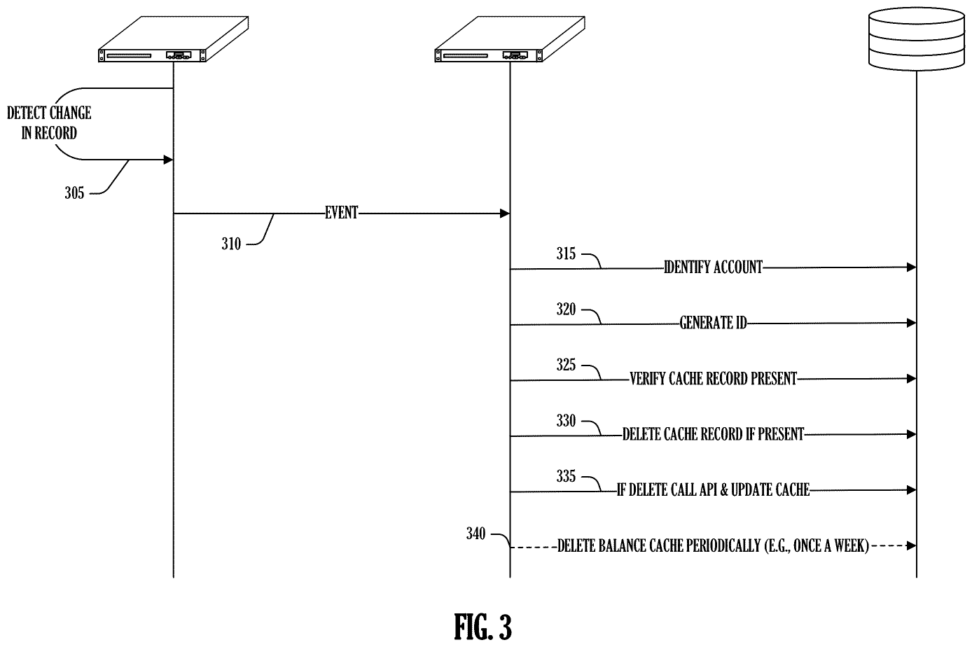

FIG. 3 illustrates an example of messaging between components including an external application programming interface call, according to an embodiment. The illustrated interaction corresponds to a use case where data is retrieved from the external service API only when accessed for the first time in a specific period (e.g., in a week, a month, etc.). Otherwise, the data is retrieved from the cache.

The local system detects a change in the record from the mirrored transaction data (operation 305). The local system then generates an event (operation 310) to a cache manager. The cache manager identifies the account (operation 315) from the cache and generates an ID (e.g., the UUID described above) for the record (operation 320). The cache manager then confirms that the cache record exists (e.g., based on the ID) (operation 325) and deletes the cache record if present (operation 330). When the record is deleted from the cache, then the external service is invoked (e.g., the API is called) and the cache is updated (operation 335). Optionally, the cache record (e.g., an account balance that is cached) is deleted periodically (operation 340).

This arrangement enables API response data to be always available in the cache for accounts once accessed. In an example, cache time-to-live can be increased from, for example, ten or fifteen minutes to weekly or monthly (or more) to a week or month or even more based on a specific functionality or data managed. The system described, in testing, has several benefits. For example, the system is highly performant, response times of around 200 milliseconds can be observed. Further, the number of calls going to cache increases (e.g., up to and exceeding forty percent), reducing the average response time. The system is also resilient, enabling better availability of application data even when downstream API is down.

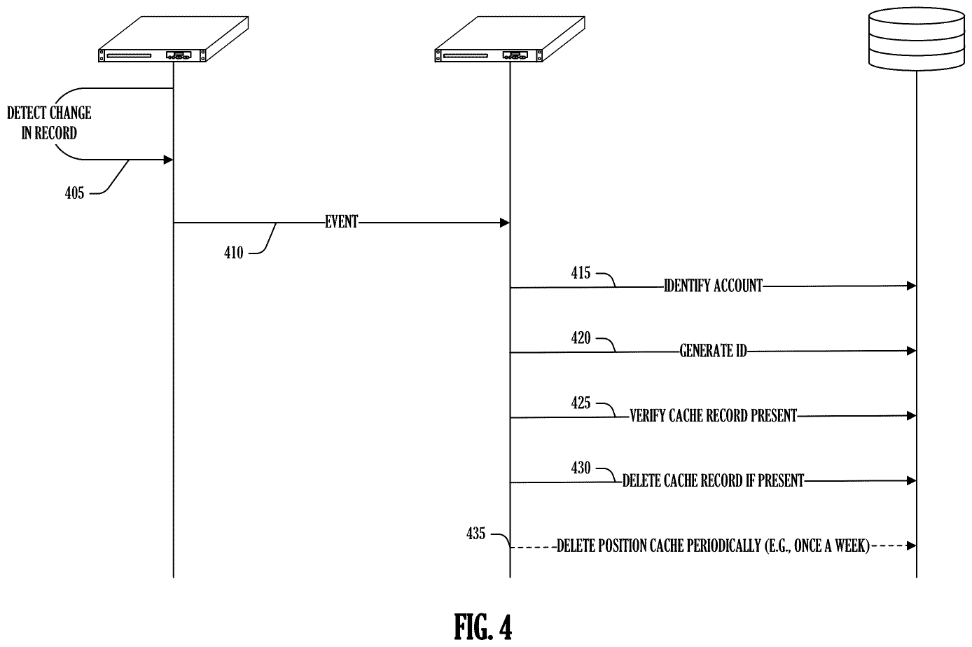

FIG. 4 illustrates an example of messaging between components, according to an embodiment. The illustrated scenario differentiates from that in FIG. 3 by deleting the cache record upon a detected data change and refraining from calling the API immediately. Thus, the illustrated scenario gets data from the external service only when an account is accessed for the first time or a position for the account is updated. Otherwise, data is retrieved from the cache in a specific period, such as a week or a month.

The local system detects a change in the record from the mirrored transaction data (operation 405). The local system then generates an event (operation 410) to a cache manager. The cache manager identifies the account (operation 415) from the cache and generates an ID (e.g., the UUID described above) for the record (operation 420). The cache manager then confirms that the cache record exists (e.g., based on the ID) (operation 425) and deletes the cache record if present (operation 430). Optionally, the cache record (e.g., an account balance that is cached) is deleted periodically (operation 435). Deleting the cache record generally causes a cache miss when another application attempts to use the cache record. This cache miss can then trigger the API call to refresh the cache in an on-demand fashion.

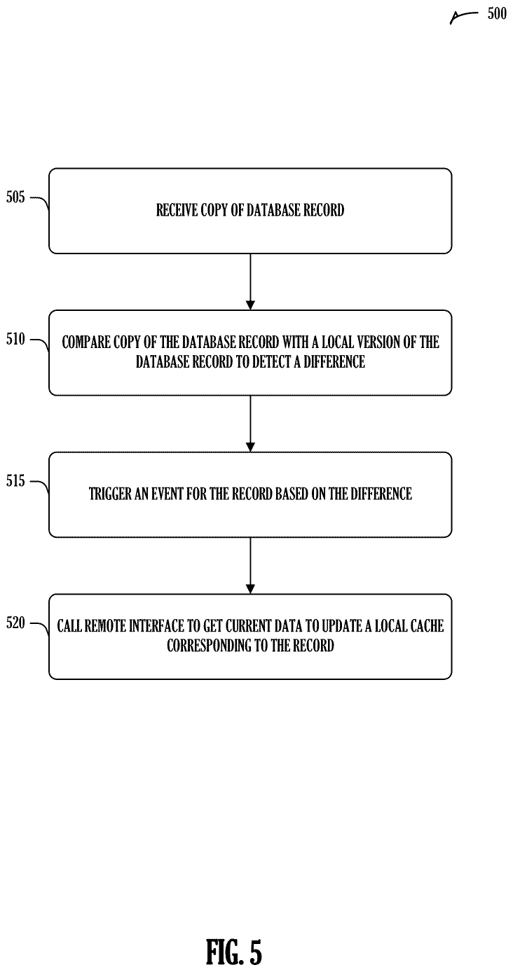

FIG. 5 illustrates a flow diagram of an example of a method 500 for external service invocation, according to an embodiment. The operations of the method 500 are performed by computer hardware, such as that described above or below (e.g., processing circuitry).

At operation 505, a copy of a portion of a database is received from an external entity. In an example, the copy includes a record. In an example, the portion of the database is a database table.

At operation 510, a local version of the record is accessed to find an indication that the record is different than the local version of the record. In an example, the indication that the record is different includes a failure to match values between the record and the local version of the record in a set of fields. In an example, the set of fields is all fields of the record. In an example, a failure to match occurs when, given a field, a first value in the record for the record and a second value in the field for the local version of the record are different from each other.

At operation 515, an event for the record is triggered based on the indication that the record is different than the local version of the record. In an example, triggering the event includes publishing a message for the event on a message bus.

At operation 520, a request corresponding to the record is transmitted to an interface to update a local cache corresponding to the record with a response to the request. In an example, data in the response includes a value that is not in the record.

In an example, the interface accepts the request, derives the value from a local source, and adds the value to the response. In an example, the interface is implemented by the external entity.

In an example, the operations of the method 500 can include generating an identifier based on the record. In an example, the identifier is a key to the local cache. In an example, the record is part of a set of records. In an example, the set of records includes meta data. In an example, the identifier is derived from the meta data. In an example, the identifier is a hash of some or a portion of the meta data.

In an example, the operations of the method 500 include deleting entry in the cache that matches the identifier. In an example, deleting the entry in the cache includes overwriting the entry with data in the response to the request.

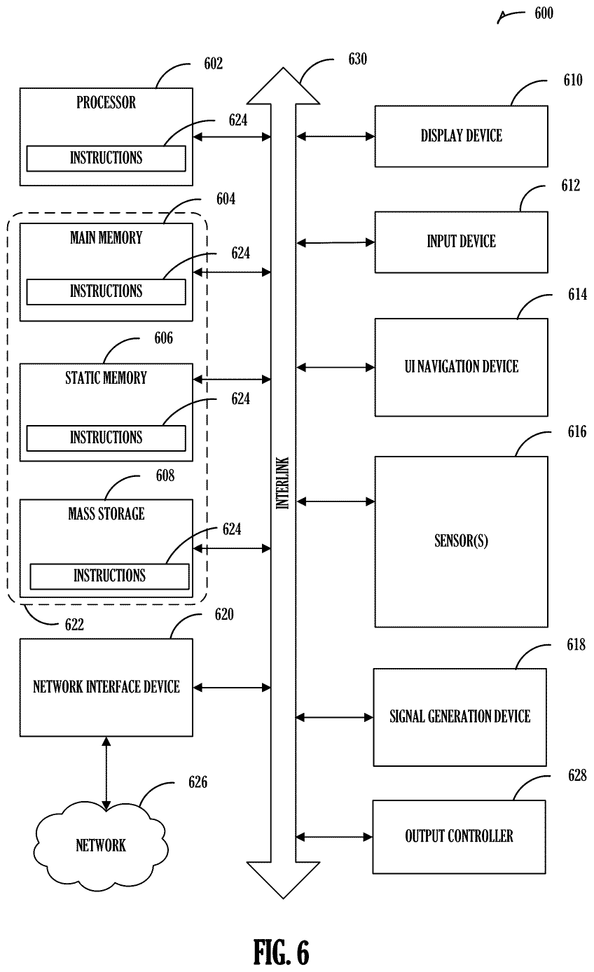

FIG. 6 illustrates a block diagram of an example machine 600 upon which any one or more of the techniques (e.g., methodologies) discussed herein may perform. Examples, as described herein, may include, or may operate by, logic or a number of components, or mechanisms in the machine 600. Circuitry (e.g., processing circuitry) is a collection of circuits implemented in tangible entities of the machine 600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 600 follow.

In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

The machine (e.g., computer system) 600 may include a hardware processor 602 (e.g., a central processing unit (CPU), a graphics processing unit (GPU), a hardware processor core, or any combination thereof), a main memory 604, a static memory (e.g., memory or storage for firmware, microcode, a basic-input-output (BIOS), unified extensible firmware interface (UEFI), etc.) 606, and mass storage 608 (e.g., hard drives, tape drives, flash storage, or other block devices) some or all of which may communicate with each other via an interlink (e.g., bus) 630. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 608, a signal generation device 618 (e.g., a speaker), a network interface device 620, and one or more sensors 616, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 602, the main memory 604, the static memory 606, or the mass storage 608 may be, or include, a machine readable medium 622 on which is stored one or more sets of data structures or instructions 624 (e.g., software) embodying or utilized by any one or more of the techniques or functions described herein. The instructions 624 may also reside, completely or at least partially, within any of registers of the processor 602, the main memory 604, the static memory 606, or the mass storage 608 during execution thereof by the machine 600. In an example, one or any combination of the hardware processor 602, the main memory 604, the static memory 606, or the mass storage 608 may constitute the machine readable media 622. While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 622 may be representative of the instructions 624, such as instructions 624 themselves or a format from which the instructions 624 may be derived. This format from which the instructions 624 may be derived may include source code, encoded instructions (e.g., in compressed or encrypted form), packaged instructions (e.g., split into multiple packages), or the like. The information representative of the instructions 624 in the machine readable medium 622 may be processed by processing circuitry into the instructions to implement any of the operations discussed herein. For example, deriving the instructions 624 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 624.

In an example, the derivation of the instructions 624 may include assembly, compilation, or interpretation of the information (e.g., by the processing circuitry) to create the instructions 624 from some intermediate or preprocessed format provided by the machine readable medium 622. The information, when provided in multiple parts, may be combined, unpacked, and modified to create the instructions 624. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 624 may be further transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software. A transmission medium is a machine readable medium.

### Additional Notes & Examples

Example 1 is an apparatus for external service invocation, the apparatus comprising: a memory including instruction; and processing circuitry that, when in operation, is configured by the instructions to: receive copy of a portion of a database from an external entity, the copy including a record; access a local version of the record to find an indication that the record is different than the local version of the record; trigger an event for the record based on the indication that the record is different than the local version of the record; and transmit, based on the event, a request corresponding to the record to an interface to update a local cache corresponding to the record with a response to the request.

In Example 2, the subject matter of Example 1, wherein the portion of the database is a database table.

In Example 3, the subject matter of any of Examples 1-2, wherein the indication that the record is different includes a failure to match values between the record and the local version of the record in a set of fields.

In Example 4, the subject matter of Example 3, wherein the set of fields is all fields of the record.

In Example 5, the subject matter of any of Examples 3-4, wherein a failure to match occurs when, given a field, a first value in the record for the record and a second value in the field for the local version of the record are different from each other.

In Example 6, the subject matter of any of Examples 1-5, wherein data in the response includes a value that is not in the record.

In Example 7, the subject matter of Example 6, wherein the interface accepts the request, derives the value from a local source, and adds the value to the response.

In Example 8, the subject matter of any of Examples 1-7, wherein the processing circuitry is configured to generate an identifier based on the record, the identifier being a key to the local cache.

In Example 9, the subject matter of Example 8, wherein the record is part of a set of records, wherein the set of records includes meta data, and wherein the identifier is derived from the meta data.

In Example 10, the subject matter of Example 9, wherein the identifier is a hash of some or a portion of the meta data.

In Example 11, the subject matter of any of Examples 8-10, wherein the processing circuitry is configured to delete entry in the cache that matches the identifier.

In Example 12, the subject matter of Example 11, wherein, to delete the entry in the cache, the processing circuitry is configured to overwrite the entry with data in the response to the request.

In Example 13, the subject matter of any of Examples 1-12, wherein the interface is implemented by the external entity.

In Example 14, the subject matter of any of Examples 1-13, wherein, to trigger the event, the processing circuitry is configured to publish a message for the event on a message bus.

Example 15 is a method for external service invocation, the method comprising: receiving copy of a portion of a database from an external entity, the copy including a record; accessing a local version of the record to find an indication that the record is different than the local version of the record; triggering an event for the record based on the indication that the record is different than the local version of the record; and transmitting, based on the event, a request corresponding to the record to an interface to update a local cache corresponding to the record with a response to the request.

In Example 16, the subject matter of Example 15, wherein the portion of the database is a database table.

In Example 17, the subject matter of any of Examples 15-16, wherein the indication that the record is different includes a failure to match values between the record and the local version of the record in a set of fields.

In Example 18, the subject matter of Example 17, wherein the set of fields is all fields of the record.

In Example 19, the subject matter of any of Examples 17-18, wherein a failure to match occurs when, given a field, a first value in the record for the record and a second value in the field for the local version of the record are different from each other.

In Example 20, the subject matter of any of Examples 15-19, wherein data in the response includes a value that is not in the record.

In Example 21, the subject matter of Example 20, wherein the interface accepts the request, derives the value from a local source, and adds the value to the response.

In Example 22, the subject matter of any of Examples 15-21, comprising generating an identifier based on the record, the identifier being a key to the local cache.

In Example 23, the subject matter of Example 22, wherein the record is part of a set of records, wherein the set of records includes meta data, and wherein the identifier is derived from the meta data.

In Example 24, the subject matter of Example 23, wherein the identifier is a hash of some or a portion of the meta data.

In Example 25, the subject matter of any of Examples 22-24, comprising deleting entry in the cache that matches the identifier.

In Example 26, the subject matter of Example 25, wherein deleting the entry in the cache includes overwriting the entry with data in the response to the request.

In Example 27, the subject matter of any of Examples 15-26, wherein the interface is implemented by the external entity.

In Example 28, the subject matter of any of Examples 15-27, wherein triggering the event includes publishing a message for the event on a message bus.

Example 29 is non-transitory machine readable media including instructions for external service invocation, the instructions, when executed by processing circuitry, cause the processing circuitry to perform operations comprising: receiving copy of a portion of a database from an external entity, the copy including a record; accessing a local version of the record to find an indication that the record is different than the local version of the record; triggering an event for the record based on the indication that the record is different than the local version of the record; and transmitting, based on the event, a request corresponding to the record to an interface to update a local cache corresponding to the record with a response to the request.

In Example 30, the subject matter of Example 29, wherein the portion of the database is a database table.

In Example 31, the subject matter of any of Examples 29-30, wherein the indication that the record is different includes a failure to match values between the record and the local version of the record in a set of fields.

In Example 32, the subject matter of Example 31, wherein the set of fields is all fields of the record.

In Example 33, the subject matter of any of Examples 31-32, wherein a failure to match occurs when, given a field, a first value in the record for the record and a second value in the field for the local version of the record are different from each other.

In Example 34, the subject matter of any of Examples 29-33, wherein data in the response includes a value that is not in the record.

In Example 35, the subject matter of Example 34, wherein the interface accepts the request, derives the value from a local source, and adds the value to the response.

In Example 36, the subject matter of any of Examples 29-35, wherein the operations comprise generating an identifier based on the record, the identifier being a key to the local cache.

In Example 37, the subject matter of Example 36, wherein the record is part of a set of records, wherein the set of records includes meta data, and wherein the identifier is derived from the meta data.

In Example 38, the subject matter of Example 37, wherein the identifier is a hash of some or a portion of the meta data.

In Example 39, the subject matter of any of Examples 36-38, wherein the operations comprise deleting entry in the cache that matches the identifier.

In Example 40, the subject matter of Example 39, wherein deleting the entry in the cache includes overwriting the entry with data in the response to the request.

In Example 41, the subject matter of any of Examples 29-40, wherein the interface is implemented by the external entity.

In Example 42, the subject matter of any of Examples 29-41, wherein triggering the event includes publishing a message for the event on a message bus.

Example 43 is a system for external service invocation, the system comprising: means for receiving copy of a portion of a database from an external entity, the copy including a record; means for accessing a local version of the record to find an indication that the record is different than the local version of the record; means for triggering an event for the record based on the indication that the record is different than the local version of the record; and means for transmitting, based on the event, a request corresponding to the record to an interface to update a local cache corresponding to the record with a response to the request.

In Example 44, the subject matter of Example 43, wherein the portion of the database is a database table.

In Example 45, the subject matter of any of Examples 43-44, wherein the indication that the record is different includes a failure to match values between the record and the local version of the record in a set of fields.

In Example 46, the subject matter of Example 45, wherein the set of fields is all fields of the record.

In Example 47, the subject matter of any of Examples 45-46, wherein a failure to match occurs when, given a field, a first value in the record for the record and a second value in the field for the local version of the record are different from each other.

In Example 48, the subject matter of any of Examples 43-47, wherein data in the response includes a value that is not in the record.

In Example 49, the subject matter of Example 48, wherein the interface accepts the request, derives the value from a local source, and adds the value to the response.

In Example 50, the subject matter of any of Examples 43-49, comprising means for generating an identifier based on the record, the identifier being a key to the local cache.

In Example 51, the subject matter of Example 50, wherein the record is part of a set of records, wherein the set of records includes meta data, and wherein the identifier is derived from the meta data.

In Example 52, the subject matter of Example 51, wherein the identifier is a hash of some or a portion of the meta data.

In Example 53, the subject matter of any of Examples 50-52, comprising means for deleting entry in the cache that matches the identifier.

In Example 54, the subject matter of Example 53, wherein the means for deleting the entry in the cache include means for overwriting the entry with data in the response to the request.

In Example 55, the subject matter of any of Examples 43-54, wherein the interface is implemented by the external entity.

In Example 56, the subject matter of any of Examples 43-55, wherein the means for triggering the event include means for publishing a message for the event on a message bus.

Example 57 is at least one machine-readable medium including instructions that, when executed by processing circuitry, cause the processing circuitry to perform operations to implement any of Examples 1-56.

Example 58 is an apparatus comprising means to implement any of Examples 1-56.

Example 59 is a system to implement any of Examples 1-56.

Example 60 is a method to implement any of Examples 1-56.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. An apparatus for external service invocation, the apparatus comprising:
a memory including instructions; and
processing circuitry that, when in operation, is configured by the instructions to:
receive a copy of a portion of a database from an external entity, the copy including a record, the record being raw data;
access a local version of the record to find an indication that the record is different than the local version of the record;
trigger an event for the record based on the indication that the record is different than the local version of the record;
transmit, based on the event, a request identifying the record to an interface of a remote service;
receive, from the remote service, a response that includes final data produced by the remote service processing another copy of the record local to the remote service; and
update a local cache corresponding to the record with the final data in the response to the request.

2. The apparatus of claim 1, wherein the indication that the record is different includes a failure to match values between the record and the local version of the record in a set of fields.

3. The apparatus of claim 2, wherein the set of fields is all fields of the record.

4. The apparatus of claim 2, wherein the failure to match occurs when, given a field, a first value in the record for the record and a second value in the field for the local version of the record are different from each other.

5. The apparatus of claim 1, wherein data in the response includes a value that is not in the record.

6. The apparatus of claim 5, wherein the interface accepts the request, derives the value from a local source, and adds the value to the response.

7. The apparatus of claim 1, wherein the processing circuitry is configured to generate an identifier based on the record, the identifier being a key to the local cache.

8. The apparatus of claim 7, wherein the record is part of a set of records, wherein the set of records includes meta data, and wherein the identifier is derived from the meta data.

9. The apparatus of claim 8, wherein the identifier is a hash.

10. The apparatus of claim 7, wherein the processing circuitry is configured to delete entry in the local cache that matches the identifier.

11. Non-transitory machine readable media including instructions for external service invocation, the instructions, when executed by processing circuitry, cause the processing circuitry to perform operations comprising:
receiving copy of a portion of a database from an external entity, the copy including a record, the record being raw data;
accessing a local version of the record to find an indication that the record is different than the local version of the record;
triggering an event for the record based on the indication that the record is different than the local version of the record;
transmitting, based on the event, a request identifying the record to an interface of a remote service;
receiving from the remote service, a response that includes final data produced by the remote service processing another copy of the record local to the remote service; and
updating a local cache corresponding to the record with the final data in the response to the request.

12. The non-transitory machine readable media of claim 11, wherein the indication that the record is different includes a failure to match values between the record and the local version of the record in a set of fields.

13. The non-transitory machine readable media of claim 12, wherein the set of fields is all fields of the record.

14. The non-transitory machine readable media of claim 12, wherein the failure to match occurs when, given a field, a first value in the record for the record and a second value in the field for the local version of the record are different from each other.

15. The non-transitory machine readable media of claim 11, wherein data in the response includes a value that is not in the record.

16. The non-transitory machine readable media of claim 15, wherein the interface accepts the request, derives the value from a local source, and adds the value to the response.

17. The non-transitory machine readable media of claim 11, wherein the operations comprise generating an identifier based on the record, the identifier being a key to the local cache.

18. The non-transitory machine readable media of claim 17, wherein the record is part of a set of records, wherein the set of records includes meta data, and wherein the identifier is derived from the meta data.

19. The non-transitory machine readable media of claim 18, wherein the identifier is a hash.

20. The non-transitory machine readable media of claim 17, wherein the operations comprise deleting entry in the local cache that matches the identifier.
